(19) United States
(12) Patent Application Publication
(10) Pub. No.: US 2005/0199675 A1
(43) Pub. Date: Sep. 15, 2005

(54) Electric stapler

(75) Inventor: Tokinori Takada, Chiba (JP)

Correspondence Address: GREENBLUM & BERNSTEIN, P.L.C., 1950 ROLAND CLARKE PLACE, RESTON, VA, 20191, US

(73) Assignee: KTF CORPORATION, Tokyo (JP)

(21) Appl. No.: 10/998,535

(22) Filed: Nov. 30, 2004

(30) Foreign Application Priority Data
Mar. 15, 2004 (JP) 2004-073321

(51) Int. Cl. B25C 5/02

(52) U.S. Cl. 227/134

(57) ABSTRACT

An electric stapler comprises a case body, a drive section consisting of a motor and gears, electrical circuitry, a magazine frame in which staples are loaded, and an arm that pushes down on staples in the magazine frame so that the staples penetrate and fasten a sheaf of documents. The staples are pressed down on a document sheaf under the weight of the magazine frame. The stapling operation is effected by the magazine frame and arm swing up and down about swingable fulcrums, with the arm pushing down on a staple stored in the magazine frame and the magazine frame swinging about a swingable fulcrum to press against the document sheaf. An elastic body is provided on the lower part of the magazine frame that urges the magazine frame and arm back to their original stapling position. A deformation prevention member is provided on the front end of the magazine frame to prevent the magazine frame from being deformed due to frequent use.

### BACKGROUND OF THE INVENTION

Field of the Invention

This invention relates to an electric stapler for fastening together a sheaf of documents or the like using a staple that punches holes in the document sheaf and is clinched. It particularly relates to an electric stapler in which a staple is simultaneously pressed by an arm and by a frame to punch holes in the document sheaf and also has a structure that prevents the frame being deformed from frequent use.

Staplers are extensively used as a tool for filing documents and the like in the form of sheaves of sheets. Most staplers are manually operated, but there are also electrically-operated staplers, devised to be used in place of manual staplers for stapling of thick document sheaves requiring more strength. Since they are electrically driven, electric staplers are able to perform binding automatically, and are therefore convenient to use. A typical example of an electric stapler technology is that disclosed in Japanese Unexamined Patent Publication No. 2000-317861.

The electric stapler of the disclosure has a structure whereby, as a dispensing arm is driven by a motor in the downward direction of a pressing member, a magazine frame moves downward at its front end under its own weight, until the lower surface of the front end of the magazine frame touches the upper surface of the object to be stapled. It is formed such that, when the pressing member is moved to its lowest point, the dimension between the catch of a suspension member and the support is a dimension such that the front end of the dispensing arm can move due to movement of the pressing member so that a staple stored in the magazine frame is pushed out from the dispensing outlet.

Also, the magazine frame has a structure comprising a case provided with a staple storage area and a case cover that covers the upper surface of the case, the structure being such that the loading of staples can be carried out by pulling the case from the case cover at the front end of the magazine frame in the case meeting area which is formed by the side wall in the lengthwise direction of the case cover and the side surface in the lengthwise direction of the case, in a long, mutually meshing groove and long protrusion.

Moreover, the constitution is such that a switch that closes the electrical circuit of the motor upon contact with the edge of the object to be stapled, which is inserted between the base and the front end of the magazine frame, is provided on a moveable member that can be moved from the front end of the magazine frame toward the back end.

Conventional electric staplers have a structure wherein the switch for actuation itself moves from the front end to the back end. Since the durability of the switch over long-term use is therefore poorer than that of a fixed switch, conventional electric staplers are prone to breakage. Moreover, the dimension between the catch of the suspension member and the support must be one that permits the engagement of the pressing member, so it naturally must be of a certain size. Also, the magazine frame is deformed by frequent use.

Therefore, a need has been felt for the development of an electric stapler having a simple structure that is able to securely perform stapling.

### SUMMARY OF THE INVENTION

The object of the present invention is to overcome the foregoing problems by providing an electric stapler in which an arm pushes down a staple stored in a magazine frame while at the same time the magazine frame swings about a swinging fulcrum to clamp the document sheaf through which the staple is driven to bind the sheets, an elastic body is provided at a lower portion of the magazine frame to return the magazine frame and arm to the original binding position, and a deformation prevention member is affixed at the front end of the magazine frame to prevent the magazine frame from becoming deformed due to frequent use.

For attaining this object, this invention provides an electric stapler comprising: a case body, a drive section constituted by a rotary drive apparatus (motor) and gears, a wiring board provided with electrical circuitry, a magazine frame that stores staples, an arm that pushes, from above, staples stored in the magazine frame to penetrate and staple a sheaf of documents or the like, wherein staples are pressed down on a document sheaf under the weight of the magazine frame and staple penetration and fastening is performed by the magazine frame and arm swing up and down about swingable fulcrums, with the arm pushing down on a staple stored in the magazine frame and the magazine frame swinging about a swingable fulcrum to press against the document sheaf, an elastic body provided on the lower part of the magazine frame that urges the magazine frame and arm back to an original document sheaf stapling position, and a deformation prevention member provided on the front end of the magazine frame to prevent the magazine frame from being deformed due to frequent use.

The above and other features of the present invention will become apparent from the following description made with reference to the drawings.

### BRIEF DESCRIPTION OF THE DRAWINGS

FIG. 1 is a side view of the electric stapler of the invention.

FIG. 2 is a cross-sectional side view of the magazine frame and arm of the stapler.

FIG. 3 is a cross-sectional side view of the magazine frame and arm prior to operation.

FIG. 4 is a cross-sectional side view of the magazine frame and arm prior to staple penetration.

FIG. 5 is a cross-sectional side view of the magazine frame and arm during staple penetration.

### DESCRIPTION OF THE PREFERRED EMBODIMENT

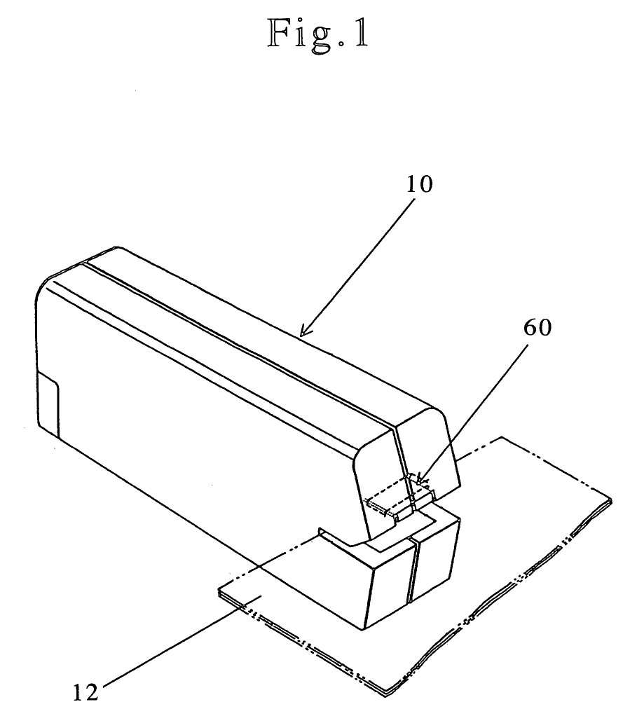

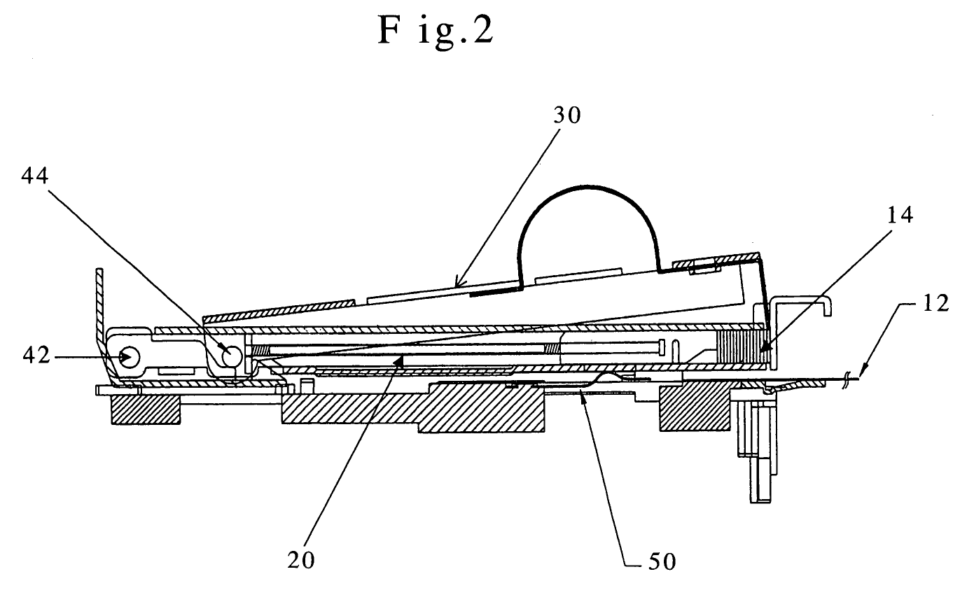

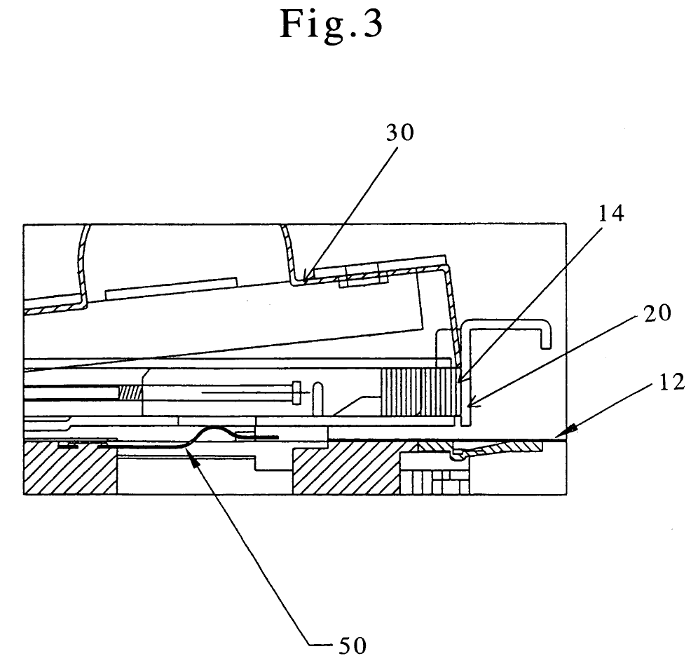

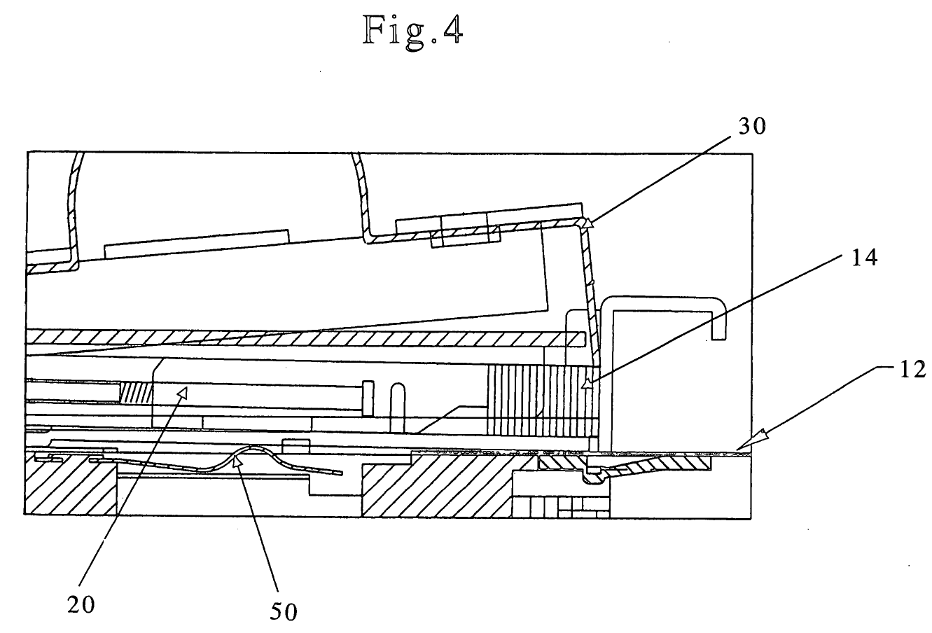

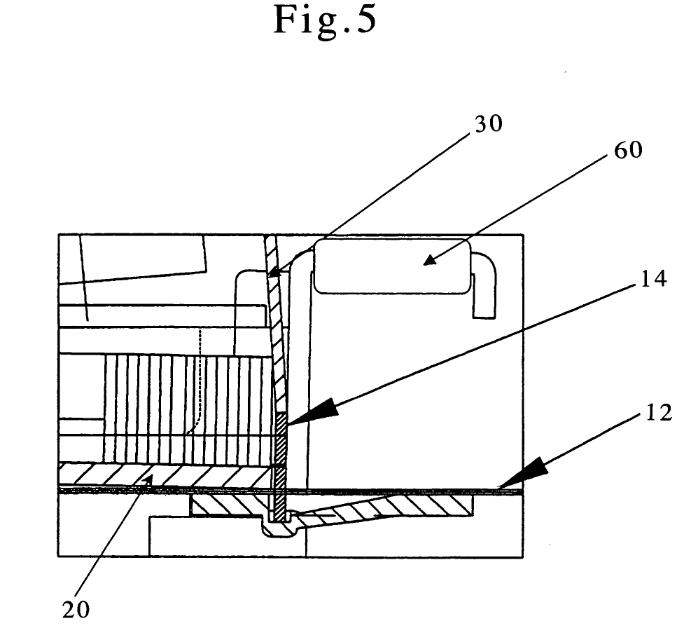

Details of the electric stapler of the invention will now be explained with reference to the drawings, in which FIG. 1 is a side view of the electric stapler, FIG. 2 is a cross-sectional side view of the magazine frame and arm, FIG. 3 is a cross-sectional side view of the magazine frame and arm prior to operation, FIG. 4 is a cross-sectional side view of the magazine frame and arm prior to staple penetration, and FIG. 5 is a cross-sectional side view of the magazine frame and arm during staple penetration.

As shown in FIG. 1, the electric stapler of the invention comprises a case body, a drive section, a wiring board, a magazine frame 20, an arm 30, an actuating bar, and a fixed switch. A conventional case body, drive section, wiring board, actuating bar and fixed switch may be used. The characterizing feature of the present invention lies in the constitution of the magazine frame 20 and arm 30, so those are the parts that will be explained.

The magazine frame 20 is a box that stores staples 14 used when stapling a sheaf of documents 12 or the like, and includes a staple guide. The staple guide is the same as the staple guide of a conventional electric stapler. The staple guides the staples 14 stored in the magazine frame 20 under pressure toward the front end of the stapler, and comprises a spring which provides the pressing force, a slide plate which is a moving body, a downward-facing U-shaped stapler guide which pushes the staples forward, a shaft, and a cap which contacts the switch at the back end of the shaft. The magazine frame 20 is made swingable through a swingable fulcrum 42 at its back end, whereby the front end of the frame can move up and down.

The arm 30 comprises a semicircular engagement circle that engages gear protrusions (not shown), and a plate-shaped driver used for pushing down staples at the front end. One of the staples lined up at the very front end of the staples stored in the magazine frame 20 is separated from the line of staples and pressure is applied to push it downward so that it penetrates the edge of documents or the like, thereby completing the operation of stapling the documents. The engagement circle is formed in an approximately semicircular shape, and is coupled to the circular motion of the gear protrusions to thereby cause the arm 30 to move up and down.

Elastic body 50 is a flat plate provided with a convexity arranged to abut the lower part of the magazine frame 20. When the magazine frame 20 is pushed down, the elastic body 50 has enough elastic force to return the magazine frame 20 to its original position. A coil spring elastic body can be used instead of the plate with a convexity of the elastic body 50 of this embodiment.

To have the weight of the magazine frame 20 push the staple on to the document sheaf and effect staple penetration and fastening, the magazine frame 20 and arm 30 swing up and down about swingable fulcrums 42 and 44, with the arm 30 pushing down on a staple 14 stored in the magazine frame 20 and the magazine frame 20 swinging about swingable fulcrum 42 to press against the document sheaf, while the elastic body 50 provided on the lower part of the magazine frame returns the magazine frame 20 and arm 30 to the original position for stapling of the document sheaf 12.

The arm 30 pushing a staple 14 stored in the magazine frame 20 causes the magazine frame 20 to push downward. The magazine frame 20 coming into abutment against the top of the document sheaf 12 in that state causes the arm 30 to push down a single staple 14 to penetrate and staple the document sheaf 12. When the stapling operation is completed, the elastic body 50 provided to abut against the lower part of the magazine frame 20 urges the magazine frame 20 back up to its original position. As a result, the stapler is always ready for staples 14 to be pressed to penetrate and staple document sheaves.

A deformation prevention member 60 is provided to prevent the front end of the magazine frame 20 from becoming deformed over an extended period of service usage time. The deformation prevention member 60 covers the tip of the magazine frame 20, preventing staples from splaying out.

In accordance with the electric stapler described in the foregoing, more stable stapling can be achieved than in the prior art, and the structure is simpler. Moreover, stable operation is enabled by the provision of a deformation prevention member on the magazine frame, which also makes it possible to achieve stable closing performance.

1. An electric stapler comprising: a case body; a drive section constituted by a rotary drive apparatus (motor) and gears; a wiring board provided with electrical circuitry; a magazine frame that stores staples; an arm that pushes, from above, staples stored in the magazine frame to penetrate and staple a sheaf of documents or the like, wherein staples are pressed down on a document sheaf under the weight of the magazine frame and staple penetration and fastening is performed by the magazine frame and arm swing up and down about swingable fulcrums, with the arm pushing down on a staple stored in the magazine frame and the magazine frame swinging about a swingable fulcrum to press against the document sheaf; an elastic body provided on the lower part of the magazine frame that urges the magazine frame and arm back to an original document sheaf stapling position; and a deformation prevention member provided on the front end of the magazine frame to prevent the magazine frame from being deformed due to frequent use.
